(19) United States
(12) Patent Application Publication
(10) Pub. No.: US 2024/0300625 A1
(43) Pub. Date: Sep. 12, 2024

(54) METHOD FOR RENEWABLE ENERGY GENERATION FROM OFFSHORE STATIONS DESIGNED FOR OPERATION IN OPEN OCEAN AND HIGH-HURRICANE REGIONS

(71) Applicant: Sunit TYAGI, Bangalore (IN)

(72) Inventor: Sunit TYAGI, Bangalore (IN)

(21) Appl. No.: 18/686,303

(22) PCT Filed: May 14, 2021
(86) PCT No.: PCT/IN2021/050462

§ 371 Date: Feb. 23, 2024

(30) Foreign Application Priority Data
Mar. 22, 2021 (IN) 202141012273

(51) Int. Cl. B63B 35/44; B63B 1/12; B63B 39/00; B63B 79/10; B63B 79/20; B63B 79/40; F03D 9/00; F03D 9/11; F03D 13/25

(52) U.S. Cl. CPC B63B 35/44; B63B 1/125; B63B 39/00; B63B 79/10; B63B 79/20; B63B 79/40; F03D 9/007; F03D 9/11; F03D 13/256; B63B 2035/4453; B63B 2035/446; B63B 2035/4466; B63B 2241/06; B63B 2241/08; F05B 2240/93; F05B 2240/95

(57) ABSTRACT

Renewable Energy (RE) sources are already one of the cheapest sources of energy available today but are variable and infirm, and the open ocean offers many opportunities to generate energy by using various disparate sources and methods on a floating station. These energy stations converting renewable energy including solar, ocean currents, wind, waves and batteries and hydrogen to store energy and provide sufficient stable power and energy as required and available most of the hours. The invention claimed here is a system to capture energy from a combination of wind, solar and ocean currents, along with batteries for storage and later use and hydrogen creation, storage and use for generation. In addition, apparatus is described that provide mechanical stability and resilience in deep open seas and reliably survive storms and hurricanes. Also described is a method for overcoming intermittency of ensuring continuous and stable energy export from the station, and finally methods to continually operate RE station in the open seas even during storms and hurricanes and survive the high winds and waves.

### PRIORITY CLAIM

This application claims priority from India Non-Provisional Patent application number 202141012273, filed on 22 Mar. 2021, entitled “METHOD AND APPARATUS FOR RENEWABLE ENERGY GENERATION FROM OFFSHORE STATIONS DESIGNED FOR OPERATION IN OPEN OCEAN AND HIGH HURRICANE REGIONS”, naming as inventor Sunit Tyagi, and is incorporated it its entirety herewith, to the extent not inconsistent with the disclosure of the instant application.

### TECHNICAL FIELD

The present invention relates to an apparatus and system for generating renewable energy in the open ocean using multiple sources of renewable energy such as wind, solar, ocean current and storage of energy using batteries and hydrogen created with renewable sources and used to generate electricity when require. The invention further relates to the apparatus designed to survive severe weather conditions such as tropical storms and hurricanes. The invention further relates to method of operation of the sources and control mechanisms to ensure steady operation with balanced generation and storage, exporting steady energy from the stations. The invention further related to methods of operation of control surfaces and mechanism to ensure operation and survivability through extreme storms.

### BACKGROUND OF THE INVENTION

Anthropogenic emissions have increased the atmospheric concentration of Green House Gases (GHG) such as Carbon Dioxide, Methane, which have changed the energy balance of Earth; with net incoming energy estimated to now be in the range of 0.8 to 1.2 W/m², leading to higher accumulation of heat. The increased accumulation of heat on Earth's surface is predicted to inexorably change the climate, with average temperatures already increasing and the runaway process will cause cataclysmic changes that cannot be averted, such as stronger storms and more extreme weather.

A large body of research and scientific thinking has gone in to address the global challenge of climate change; and much of it has focused on reducing the GHG emissions, so as to slow down the process, by encouraging renewable energy generation, higher efficiency devices as well clean carbon technologies. In addition, since concentrations of GHGs in Earth's atmosphere have already increased due to past emissions, that have led to irrevocable changes in energy balance, to counter these baked-in emissions, research is ongoing on technologies to decarbonize, or reducing the GHG in atmosphere by capturing and sequestering carbon and other compounds. However, these technologies for clean generation, cleaning the air and efficient consumption are all expensive—increasing the cost of energy by 25% to 50%, making their adoption slow and difficult.

In this application, we present technology for wide spread deployment of renewable energy in areas that are prone to extreme weather such as storms with strong winds, including hurricanes of highest categories. Our invention further extends deployment of renewable energy technologies to offshore ocean areas ensuring longevity and minimizing cost. The goal is to deliver a renewable energy generation system that will not only counter the ill effects of climate change, but also survive the expected extreme events on account of it.

The advent of industrial revolution and burgeoning world population has led to significant increase in burning of fossil fuels, and as a result the atmospheric concentration of CO₂ has increased steadily and is now over 50% higher than that of the pre-industrial age. Higher GHG concentration in the atmosphere gives higher downward infrared radiation from the green house gases that act like a blanket for the atmosphere this gives higher energy imbalance, and accumulation of heat on Earth's surface. With the higher GHG concentration, energy imbalance on planet surface has steadily increased and the current estimates range from 0.8 W/m² to 1.2 W/m². The higher energy imbalance has led to increasing surface temperature of the Earth over the past century, where the increase in surface temperature is clearly observable in the recent decades, and has emerged from the background of decadal natural variations, and rising roughly 0.7 degrees Centigrade in last 50 years, for an average rise of 0.14 degrees/decade.

The higher average temperatures across the globe will potentially cause stronger longer lasting storms with higher wind velocities and heavier rainfalls. These stronger storms and hurricanes pose special challenge to use of renewable energy sources such as windmills and solar power generation. This is because a hurricane with dense cloud cover and lasting for days can block sunlight and limit the generation from solar plants that are increasingly important source of electric generation. In addition due to the high wind speeds today's design of windmills cannot operate beyond a cutoff wind speeds, the generation from windmills are typically limited for wind speeds below 20 to 45 meters/second. Windmills blades are airfoils designs with variable pitch to control the angle of attack with respect to incident wind. For very high wind speeds, the pitch is varied to cause stalling and reducing the lift force to limit any potential damage due to the heavy winds, and this loss of lifts leads to no motion of the blades, stopping generation. The weakest hurricanes (typhoons) of Category 1 usually have wind speeds that can exceed these critical speeds, thus even generation from windmills may not be possible during a hurricane. Thus both solar photovoltaic plants and windmills may have limited generation during hurricanes and heavy wind season, potentially limiting their usefulness in many areas across the globe.

Another important consideration is the expected opportunity to use offshore windmills to capture steady and high potential source of energy from wind blowing across the open oceans. These offshore windmills present the technological challenges of floating, anchoring, and operating in the open oceans; such offshore windmills have also to be able to address and survive unpredictably strong winds and storms, necessitating much more expensive designs.

For offshore generation the design of windmills is combined with other renewable energy sources such as photovoltaic solar arrays and ocean currents in order to provide stable power leveraging the complementarity of generation sources and also multitude of other benefits including better mechanical stability, resilience to rough seas and ability to provide near continual energy.

These renewable energy designs are particularly important for areas affected by Hurricanes such as Andaman and Lakshadweep Islands, Eastern Coast of India and United States extending South to Florida and Gulf coast, Caribbean Islands, Eastern coast of Japan, Philippines, Taiwan, etc.

### SUMMARY OF THE INVENTION

Increasing Green House Gases concentration in atmosphere due to anthropogenic emissions is leading to an additional energy accumulation of roughly 0.6 to 1 W/m², and today this is causing an increase in global temperatures by roughly 0.17° C. per decade. The common suggested approach to address this trend, and to avert worst-case cataclysmic impact, has been to reduce the emissions by not using fossil fuels and using renewable energy instead. There are several issues with this approach firstly the adoption and penetration of renewable energy is still low and thus today it provides only a minor fraction of the total generation sources. The low adoption was mainly due to their high cost, also since the renewable sources are affected by incoming natural sources, the variability in generation is very high and less predictable, this impacts adoption and this concern is being addressed by using energy storage such as batteries but that adds to the expense. Secondly although adopting only the strategy of reducing fossil fuel consumption is helpful, since the accumulated amount of GHG already emitted and in the atmosphere today, this will continue heating the planet and increasing the temperatures, so even stopping the emissions today will not reverse the trends underway. So with the currently adopted approaches the planet warming trends cannot be reversed.

One very important impact of the GHG driven global warming and climate change is the increasing strengths of tropical storms, these are gathering higher amount of moisture and building up into high wind speeds. The impact of the warmer weather is going to be stronger storms and hurricanes that are going to be longer lasting with thicker cloud cover, with heavier rains over wider expanse that will leading to flooding, and with very strong winds at a site for multiple days. If renewable energy sources are the predominant source of energy, as is required in order to reduce the fossil fuel consumption, it is imperative that these energy generation sources continue to operate despite the storms or hurricane impacting an area for days altogether.

Storms and hurricanes have a significant impact on renewable energy generation. For instance, electricity generation from solar photovoltaic plants depend on the intensity and duration of incoming sunlight, and during stormy days and hurricane weather the irradiation drops significantly due to the clouds and rains. This lower amount of radiation will greatly reduce the energy output. In addition, solar plants may have to be shutdown due to safety concerns during a storm due to heavy winds and any flooding of the plant that can lead to electrical shorting of equipment. Generally, energy generation from solar plants can be very low due to the rainy and cloudy weather during tropical storms, gravely impacting grid stability. Similarly, conventional windmill are designed to cut off motion of blades and electricity generation if the wind speeds are greater than some critical value, typical cut off speeds are ranging from 25 to 40 m/s. This means that during strong tropical storms and hurricanes the energy generation from windmills will be significantly curtailed and even completely removed from the grid. This again leads to significant impact on the grid stability and ability to provide power to the community.

Such conditions are especially important for island communities that increasingly rely on renewable energy sources in forms of micro-grids with solar, wind and other sources. Many of these islands, unfortunately also suffer due to direct traversal of tropical storms and hurricanes at regular frequencies.

The shortcomings of the prior art are overcome and additional advantages are provided by this invention that consists of three main constituent groups of apparatus and methods.

Firstly, a system is described herein that is floating in open ocean and can operate continually and can survive storms and hurricanes with extremely high wind and rough sea conditions, the system has built in apparatus, sensors and actuators, used for floating under extreme conditions and this floating platform is used for placement of off shore renewable energy sources including windmills, solar and ocean turbines.

Secondly, a system is described that is located offshore providing stable and firm power comprising electrical power generation from windmills, solar photovoltaic, ocean currents and other renewable energy sources that are operable independently and in coordination. The system works under varying conditions of bright sunshine and even nights, with winds varying from very low values to extremely high and with steady or seasonal ocean currents. One aspect of invention is design of apparatus for floating renewable energy station with balanced power from Wind, Solar, Ocean Currents and Hydrogen storage and generation. The overall system arrangement uses the combination of various electrical generation systems and machineries to ensure resilient and safe operations under adverse conditions.

Thirdly, methods leveraging algorithms of reinforcement learning and deep learning are described to ensure stable operation and steady export of energy to the grid by balancing generation from various sources and using energy storage to smooth out the energy flow. Also specific methods are used to ensure stability of floating platform and enhancing the survivability during storms and rough seas and weather.

The various aspects of the invention are elaborated further here, however these description should not be taken to be exhaustive in any way, and are only illustrative to clarify the nature of the inventions and different novel embodiments and many variants of these are possible and understood by those trained in the art.

In one aspect of the invention is the need for renewable floating station to be placed safely in the open ocean, for this purpose floating platforms are to be built. In one embodiment these platforms are built using an arrangement made out of hollow pipes, in these flexible pipes are connected together to form closed volumes, the pipes themselves can be made of inert and stable plastic material such as segmented Chlorinated Poly Vinyl Chloride (CPVC), or High Density Poly Ethylene (HDPE), or carbon fiber lined resin composite and other materials which maybe suitable for long term use in open ocean and can survive unattended over extended period of service life. These hollow pipes are joined together to form hollow hexagonal, polygonal, circular rings or an annular torus. The hollow pipes may be bent to form the polygonal, circular perimeter, or be made with number of angular bends forming a many sided polygon, whose shape approaches that of a circle. The closed perimeter formed with pipes and obtuse angled joints (with bend angle greater than 90 degrees but less than 180 degrees) is found to be stable and leads to minimal flexural stress on the pipes and thus ensure long life in the open waters despite repeated movement due to waves and rough seas.

The buoyancy provided by this pipe structure can be estimated as follows, assuming the pipe diameter is D, the cross sectional area it encloses is Pi*D²/4;

the pipe itself is bent to form a circular ring by closing the ends onto itself, the radius of this ring is assumed to be R, the circumference of this circle is 2*Pi*R;

the volume of the water this annulus will displace is therefore 2*Pi*R*Pi*D²/4, that is the volume is Pi²*R*D²/2;

With commercially available pipes with diameter D going up to 1 meter, the radius of the ring can easily be 100 meters or more, so in that case the enclosed volume will be Pi²*R*D²/2˜492 cubic-meter. Which means that the ring can easily support around 490 tonnes of weight.

The closed hollow waterproof pipe ring structure provides good buoyancy, and this annular buoyancy from the pipes is augmented with a membrane stretched across the area and tied to the circumference of hollow pipes, the membrane floats on top of the surface of water and making a floating platform. This membrane is waterproof and allowed to touch the water acting like a raft, as a result the overall buoyancy is augmented, because when the membrane raft presses down on the water due to added weight, it displaces the water beneath it, even if there is a displacement h meters the buoyancy for a ring radius R, the area is Pi*R², which for R˜100 m, Volume Displaced=31400*h, even if h˜0.01 i.e. 1 centimeter only, the volume is 314 cubic meters, that means the platform can provide additional buoyancy of 300 tonnes for each centimeter of displacement.

On top of this floating platform, different types of renewable energy sources are placed and connected to form a floating renewable energy station. If the ring radius is 100 meters, then it is possible to house a solar array of around 10,000 solar panels, (around 4 to 6 MW) each of the panel weighs around 25 kilograms, for a total solar array weight of 250 tonnes. Clearly the ring itself provides enough buoyancy, in case additional weights such as batteries and hydrogen are considered as loads on the membrane platform or raft that displaces some of the water down below the buoyancy from the membrane will be more than sufficient. To support a weight of 300 Tonnes the diameter D can be reduced down to 0.8 meter. However to support much heavier wind turbines much larger areas will be needed.

In another embodiment, multiple such smaller floating platforms can be connected together in a hexagonally packed arrangement that is itself encased with a peripheral bounding hose to ensure tight packing of a flexible array of platforms and provide additional buoyancy if required.

In another aspect of the inventions, the windmills engineered to operate in high wind conditions and can be also generating electrical energy during a hurricanes are supported on the floating platform. However as the wind turbine industry requirements for more efficient and economical windmills are pushing engineering towards higher towers with larger blade diameters, unfortunately these larger structures are much more prone to damages by high winds. Also, it is important to recognize that, most windmills depend on a self limiting design of airfoil, that depends on the boundary layer separating and the lift which moves the blades reducing steeply due to stall at high wind speeds. Yet, there is a great risk of toppling over and damage to large windmills due to turbulent and gusty high winds during hurricanes and this limits use of windmills in areas prone to hurricanes and typhoons, a concern which will increase further now due to higher likelihood of hurricanes with Category 3 and above (super-typhoons) caused by global warming.

In one aspect of the invention a robust design for windmills that can survive extremely high winds expected even in a Category 5 hurricane, with system designed to reduce the risk of damage due to heavy turbulent winds. In addition the windmills are engineered to operate in high wind conditions and can be also generating electrical energy during a hurricane, consisting of apparatus for generating electricity from wind by using novel wind turbines have requisite designed strength to be able to operate over wider range of speeds and reliably survive storms with greatest wind speeds better than possible with prior art, with an arrangement of apparatus that adjusts aerodynamic profile for the system according to the wind speed, so as to operate the wind turbines safely and even stow the wind turbine with low area of cross section when critical speed is exceeded.

Typical wind turbines being manufactured for offshore wind generation are being sized to generate high power from ranging from 10 MW to 20 MW. The tower heights range from 100 m to 150 m, weighing between 600 to 700 tonnes, and rotor blade lengths of 80 to 150 m, each weighing between 50 tonnes to 75 tonnes, the rotor hub will weigh in the range of 200 to 300 tonnes. The nacelle housing the generator and other machineries will weigh between 400 to 600 tonnes. The complete wind turbine assembly therefore is weighing in the range of 1300 tonnes to 1900 tonnes. To counter this weight with buoyancy requires total volume of 2000 cubic meter. In order to displace that much volume assuming hollow air filled cylinders of 10 m diameter (equal tower outer diameter at the base) the length required is in range of 15 to 25 meter only. Extending the tower below the water line acting as a keel of 25 meter length will be enough to offset the turbine blade with buoyancy, it also can be achieved by arranged multiple submerged chambers that can be shorter cylinders forming a rigid arrangement say 2 cylinders of 12 meters length each, or 3 cylinders of 8 meters length each or 4 cylinders of 6 meter length that together. However this passive keel does not guarantee stability against toppling over due to gravity, as the torque from off center weight of hub, rotor, nacelle assembly will cause irrecoverable tipping over under very heavy wind forces.

In one aspect, an ocean turbine and the wind turbine are designed to be as a single tower and keel, connected and placed naturally in opposition to each other, where the wind turbine is vertically upwards and the ocean turbine is submerged below the surface of water extending roughly 10 to 30 meters deep. The submerged ocean turbine provides sufficient buoyancy with volume to offset the weight of the tower and the wind turbine as a whole. While the thrust of wind used to rotate the blades leads to forces and torques from the wind turbine that could be acting to tip over the wind turbine, and when the angle to vertical increases significantly the weight of the turbine nacelle starts to fall down. This gravitational torque is naturally and significantly countered by the gravitational forces acting on the submerged ocean turbine that can be equally heavy in terms of weight of the hub, nacelle and rotor, This counter weight would than have to be raised in order for the wind turbine to fall, thus the opposition of the gravitational torques reduces the likelihood of catastrophic tipping over.

The relative balance of forces and torques will ensure stability and recovery from any large-scale displacement and tilting. The balance of forces means that total weight of all the components are counteracted by the buoyancy forces created by the displacement of water by keel formed by submerged chambers or the annulus rings, outer ring, and even the platform raft made by the stretched membrane. Meaning the weight of the hub (W_{H}), weight of the nacelle (W_{N}), weight of the rotors (W_{R}), weight of tower W_{T}, weight of ocean turbine, W_{O}, countered the net buoyancy forces F_{B} of the submerged chambers and buoyancy force of the platform F_{P}.

So the vertical forces balance equation gives

$${F}_{P} + {F}_{B} - {W}_{H} - {W}_{N} - {W}_{R} - {W}_{T} - {W}_{O} \geq 0 \qquad Eq . 1$$

That implies that the buoyancy from platform has to be assured to be

$${F}_{P} > {W}_{H} + {W}_{N} + {W}_{R} + {W}_{T} + W o - {F}_{B} \qquad Eq . 2$$

Sufficient Buoyancy force is needed in order for the system to stay afloat or bounce bank up.

Similarly for the balance of torque and net torque required for stability against tipping over, assuming the tower is tilted to an angle θ with respect to the vertical (positive for clockwise tilt) around the axis of rotation roughly at the intersection of tower and water surface. The torques that act to accelerate the fall (positive for clockwise) are the ones which will be due to gravitational force on the hub (W_{H}), nacelle (W_{N}), rotors (W_{R}), all assumed at height T_{H}, Tower (½ T_{H}) with weight W_{T} i.e. weights above the water surface; and also the torque due to the buoyancy forces F_{B} by the submerged chambers (depth T_{B}). These and are counteracted by the negative torque (counterclockwise) of weight of ocean turbine, W_{O} at depth T_{O}, all of these forces are acting along the tower length and the effective torque moment arm is with a multiplier of sinθ. On the other hand the torques due to gravity acting on the mass arrangement on the horizontal platform such weight of solar array is nearly symmetrical about the tower, so because the center of gravity and axis of rotation are coincident, this adds net nearly zero torque due to gravity. However, the tilting of the rigid structure will result in one side of platform being lifted while the other side is lowered into the water, this leads to asymmetric change in the platform or raft buoyancy with the large buoyancy from the area being forced to submerged. The laterally displaced large buoyancy with a moment arm of roughly ¼th the horizontal span L i.e. L/4, of the whole platform, this gives an additional upward buoyancy force F_{P} and counterclockwise torque−cosθ*L/4*F_{P}.

The net value of this torque has to be negative in magnitude (i.e. net torque is counterclockwise) so that the platform will try correct itself and come back towards tower being nearly vertical. This means that the

$$sin θ * \{ {T}_{H} * ( {W}_{H} + {W}_{N} + {W}_{R} + {W}_{T} / 2 ) - {W}_{O} * {T}_{O} + {F}_{B} * {T}_{B} \} - {F}_{P} * L / 4 * cos θ < 0 \qquad Eq . 3$$

This requires that the buoyancy F_{P} from platform be such that

$${F}_{P} \geq 4 / L * tan θ * \{ {T}_{H} * ( {W}_{H} + {W}_{N} + {W}_{R} + {W}_{T} / 2 ) - {W}_{O} * {T}_{O} + {F}_{B} * {T}_{B} \} \qquad Eq . 4$$

As long as Eq. 4 is assured the platform can self correct from any tilting.
In the case of a wind force acting from left to right on the hub F_{W} which gives a torque T_{W}=F_{W}*T_{H}, Equation 4 is modified as follows

$${F}_{P} \geq 4 / L * tan θ * \{ {T}_{H} * ( {W}_{H} + {W}_{N} + {W}_{R} + {W}_{T} / 2 ) - Wo * To + {F}_{B} * {T}_{B} \} + {F}_{W} * {T}_{H} \qquad Eq . 5$$

This additional torque can be very high under cases of extreme wind and the value of FP may alone not be sufficient to counter the torque, so other means are needed.

In another aspect, these wind and ocean turbines can be actively operated in concert to balance the net torques and forces and stabilize the system as a whole. In yet another aspect, the power generated by other renewable energy sources on the station such as solar, is used for rotating the ocean turbine turning it as propellers and this rotation can be used to create thrust and torques that oppose the tendencies of thrust and torques created by the wind turbine. In one aspect the design of the system is done to counteract the forces of the wind and rough seas to stabilize the station.

If lateral thrust created by ocean turbine is F_{O}, the torque created is F_{O}*T_{O} This active controlled and actively generated torque can be used to correct the tipping or control the acceleration and reduce angular tipping and oscillations with overall torque equation 5 is modified to Equation 6 to include active torque F_{O}*T_{O}

$$Fo * To + {F}_{P} \geq 4 / L * tan θ * \{ {T}_{H} * ( {W}_{H} + {W}_{N} + {W}_{R} + {W}_{T} / 2 ) - Wo * To + {F}_{B} * {T}_{B} \} + {F}_{W} * {T}_{H} \qquad Eq . 6$$

The forces and torques due to wind, gravity and sea currents and waves are actively countered and balanced by the apparatus to ensure stable and safe operation of the station using the mechanism controlled using advanced algorithms using artificial intelligence.

In another aspect the arrangement of floating platform, which maybe built on framework of hollow pipes, placed on top of the platform are generating sources such as solar, wind and ocean turbines. This structural arrangement consists of a mix of flexible and rigid framework with wide platform base, the width of platform ranges from 10 meter to 100s of meter. The platform may have width that is higher than the height of wind turbine tower, which may range from 20 to 300 meters, thereby ensuring that the center of gravity of the rigid structure does not easily move past the base of the platform, which could lead to catastrophic tipping over of the rigid arrangement. The arrangement of platform and tower goes to reduce the tendency of the wind turbines to topple and fall down, as the rigid arrangement forces the toppling tower to try to lift the solar array and this makes it difficult for wind turbine tipping to fall over due to gravitation forces acting on the additional weights of the solar array and storage elements, that work to keep the center of gravity close to the surface of the water. Yet enhances buoyancy with raft made from platform.

In another aspect of the system, the renewable sources located together are operated to provide stable and firm power to the outgoing grid line as it is comprising complementary electrical power sources of windmills, solar photovoltaic, ocean currents and other renewable energy sources and storage schemes that are operable independently and in coordination. Solar generation operates during sunshine hours, and is predictable within reasonable limits (+/−10%) to deliver peak power around noontime. Wind turbines operate across different times of day and night depending on prevailing wind conditions; typically near land masses and islands winds pick up during early morning and late evening hours due to the temperature and pressure differential that is built up between the ocean water and land due to solar heating. In case of ocean currents, these depend on long term patterns but are mainly vary during day affected by tidal forces, and that will impact the generation by ocean turbines. In one embodiment by collecting various renewable sources together, the system can generate near steady power under varying conditions of very bright sunshine or low to no sunshine, and even nights, by combining solar with complementary sources. Similarly wind turbine alone would give variation as winds vary from very low values to extremely high, this generation can be complemented with solar and ocean turbines with steady or seasonal ocean currents.

In one embodiment, the energy generated during peak hours is stored onboard in form of electrical energy in devices such as chemical batteries perhaps made with solid state or electrolytic and flow formulations or passive electrical devices such as super capacitors or even tank circuits made of inductors and capacitive. These batteries and storage circuits can then be discharged during the lean hours of generations such as combination of no sunshine and low prevailing winds, by doing so the electrical storage can be used to ensure steady supply of energy to be exported continually.

In one embodiment, the energy generated during peak hours is stored onboard in form of chemical energy such as by generating hydrogen via electrolysis and that pressurized liquid is then stored onboard containers. The stored hydrogen can then be used to generate electricity using fuel cells during the lean hours of generations such as combination of no sunshine and low prevailing winds, by doing this the chemical and electrical storage can be used to ensure steady supply of energy to be exported continually.

In one aspect of the invention the energy micro-grid apparatus is designed for the floating renewable energy station with balanced power derived from combined generation by Wind, Solar, Ocean Currents and Hydrogen fuel cells or storage and electrochemical battery for storage. The overall system arrangement is connected to a data collection, analysis and processing system that uses the combination of information from various electrical generation systems and machineries to ensure resilient and safe operations in conjunction with forecasts for expected weather conditions. Weather forecasts are used to predict generation from solar, wind, ocean currents, this generation information is used to optimize instantaneous power and energy balance over a specified duration; the energy can be output or stored over few hours or days. The power output should remain constant even under adverse conditions such as storms and hurricanes, weather systems that would otherwise upset the generation from regular renewable sources. The data processing system controls and modifies the magnitude of different types of generation (solar, wind, ocean, fuel cells), storage (batteries and hydrogen) tp ensure steady supply of power to the grid. Using the information and controlling this mix reduces the variability in renewable energy power that would otherwise limit its usefulness.

In another aspect, a set of offshore system for generating electrical power is described with generation from windmills, in conjunction with platform of solar photovoltaic, and counterbalancing ocean turbines generating from ocean currents and other renewable energy sources that are stabilized, ruggedized and operable offshore under stormy conditions of high wind, rough seas and heavy waves.

In another aspect of the invention, a method is described to control the offshore system with active sensing, controllable actuators and machine learning algorithm for feedback mechanism to provide dynamic correction as required to ensure stable operation under high wind and wave conditions. The system uses embedded sensors that provide real time feedback and adjusts profile by operating specifically located actuators, so as to ensure that the windmills survive in extremely high wind conditions.

In another aspect of the invention, a method using a computer system is described to control an apparatus that adjusts aerodynamic and mechanical profile for the overall renewable stations system according to the wind speed, so as to safely operate the wind turbines, ocean turbine, solar array and storage system. The method takes data collected from weather forecasts, measurements from embedded sensors reporting the local instantaneous and historical wind speeds, stresses and forces on the structures. These data sensors and information processing system provide real time information, and feedback on any adjustments done and the computer uses deep learning and other artificial intelligence algorithms to adapt the profile by operating specifically located actuators, so as to ensure that the windmill survive in extremely conditions with strong winds and highs waves. The adaptation includes proactively stowing the wind turbine to present low area of cross section when critical speed is exceeded.

In addition the method uses combination of all renewable energy sources to ensure the overall system is stabilized, ruggedized and operable offshore under stormy conditions of high wind, rough seas and heavy waves.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1. A platform of polygonal or circular floats with hollow pipes forming circumference of floating rings and membranes to provide buoyancy in the center

FIG. 2. An embodiment for an offshore wind turbine on a floating platform of circular floats made of hollow pipes forming circumference of floating circular rings and membranes to provide buoyancy in the center.

FIG. 3. An embodiment for an offshore wind turbine on a floating platform with rigid beam at the bottom of a platform on top of circular floats made with hollow pipes and membranes to provide buoyancy.

FIG. 4. An embodiment for an offshore wind turbine on a floating platform with multiple rigid beams at the bottom of a platform on top of circular floats made with hollow pipes and membranes to provide buoyancy.

FIG. 5.A An embodiment for an offshore wind turbine on a floating platform

FIG. 5.B An embodiment for an offshore wind turbine with adjustable aerodynamic profile on a floating platform

FIG. 5.C An embodiment for an offshore wind turbine with adjustable aerodynamic profile on a floating platform with a counter balancing ocean turbine

FIG. 5.D An embodiment for an offshore wind turbine with adjustable aerodynamic profile on a floating platform of an array of smaller floats with a counter balancing ocean turbine

FIG. 5.E An embodiment for an offshore wind turbine with adjustable aerodynamic profile on a floating platform of an array of smaller floats with solar array, battery container and a counter balancing ocean turbine

FIG. 6 Forces acting on a tilted offshore Renewable Energy Station mounted on a floating platform with wind turbine, an array of smaller floats with solar array, battery container and a counter balancing ocean turbine

FIG. 7. An embodiment for an offshore renewable energy system supplying steady power with power combiner taking variable power from different sources and energy storage

FIG. 8. Method for control of floating renewable energy using Al algorithms for controlling weather related variability to ensure stable generating operations.

FIG. 9. Method for control of highly reliable and resilient floating renewable energy using AI algorithms for adaptation and control to ensure safe operations and survival under stormy conditions.

### DETAILED DESCRIPTION OF THE INVENTION

As used herein, the terms “solar photovoltaic”, “PV system” “PV modules” and “solar cells” are used interchangeably, and unless otherwise specified include any solar cells, cables, DC-DC convertors or inverters along with electronics controllers, housing, frames, structures, etc., having one or more electricity generating components for converting energy from sunlight to electricity suitably converted and generated.

Firstly, design for a system with apparatus, sensors and actuators are described herein, for windmills that can survive and operate in extremely high wind conditions.

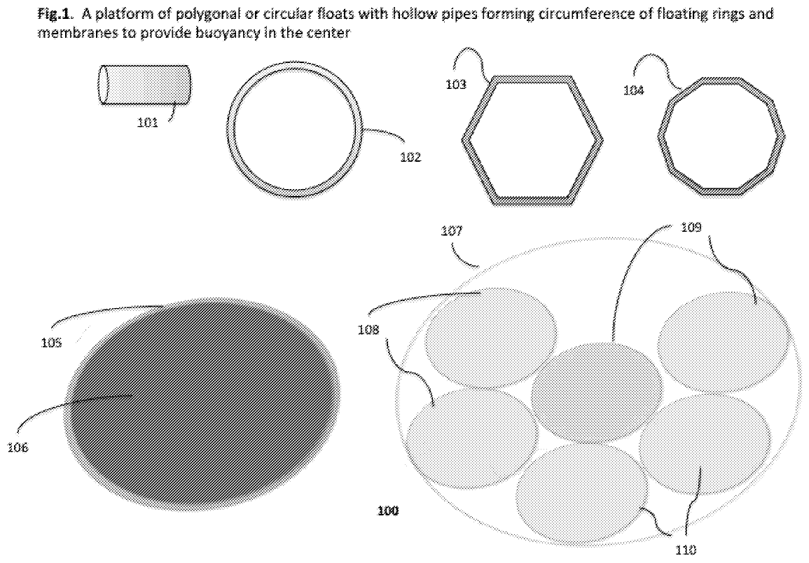

FIG. 1 depicts how a floating platform 100 renewable floating station to be placed safely in the open ocean, platform 100 is built using an arrangement made out of hollow pipes multiple pieces and lengths of sealed tube or pipe 101. The pipe 101 can be made out for this purpose floating platforms are made of inert and stable plastic material such as segmented Chlorinated Poly Vinyl Chloride (CPVC), or High Density Poly Ethylene (HDPE), or carbon fiber lined resin composite and other materials which maybe suitable for long term use in open ocean and can survive unattended over extended period of service life. These flexible pipes segments 101 are connected together to form closed hollow volumes such as hollow hexagon 103, polygon 104, circular rings 102 or an annular torus. The hollow pipes may be bent to form the polygonal, circular perimeter, or be made with number of angular bends forming a many sided polygon 104, whose shape approaches that of a circle. The closed perimeter formed with pipes and obtuse angled joints (with bend angle greater than 90 degrees but less than 180 degrees) is found to be structurally stable and resilient and leads to minimal flexural stress on the pipes and thus ensure long life in the open waters despite repeated movement due to waves and rough seas. The closed hollow waterproof pipe ring structure 105 provides good buoyancy, and this annular buoyancy from the pipes is augmented with a membrane 106 stretched across the area and tied to the circumference of hollow pipes, the membrane floats on top of the surface of water and making a floating platform. This membrane is waterproof and allowed to touch the water acting like a raft bottom, and as a result the overall buoyancy is augmented, because when the membrane raft presses down on the water due to added weight, it displaces the water beneath it. In order to provide larger areas of coverage, multiple such smaller floating platforms 108, 109 and 110 can be connected together in a closed packed arrangement that is itself encased with a peripheral bounding hose 107 to ensure tight packing of a flexible array of platforms and provide additional buoyancy as required.

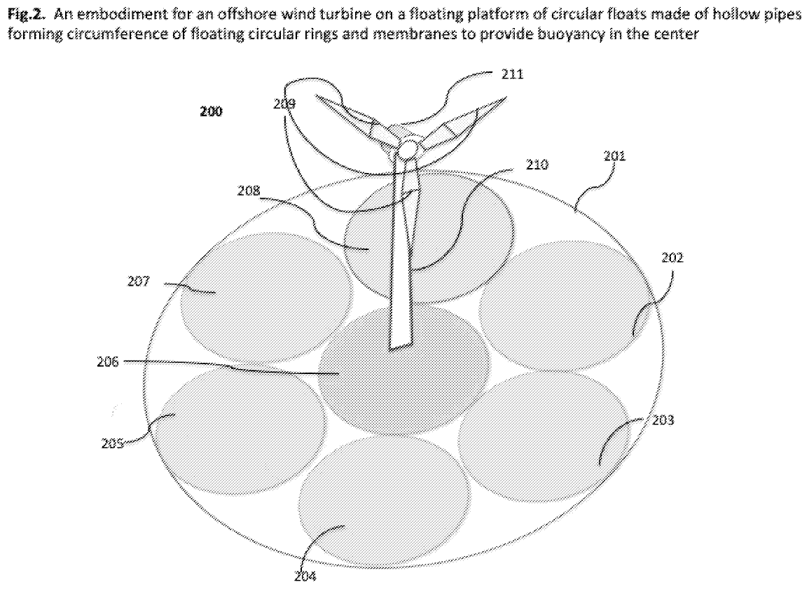

FIG. 2 depicts an arrangement 200 where the floating platform consisting of multiple such smaller floating platforms 202, 203, 204, 205, 206, 207, and 208 that are connected together in a closed packed arrangement that is itself encased with a peripheral bounding ring 201 to ensure tight packing of a flexible array of platforms and provide additional buoyancy as required. The central platform 206 has mounted on it the wind turbine tower 210 with rotors 209 and hub 211 installed on top of the tower. The overall system arrangement provides required buoyancy to ensure wind turbine floats as required.

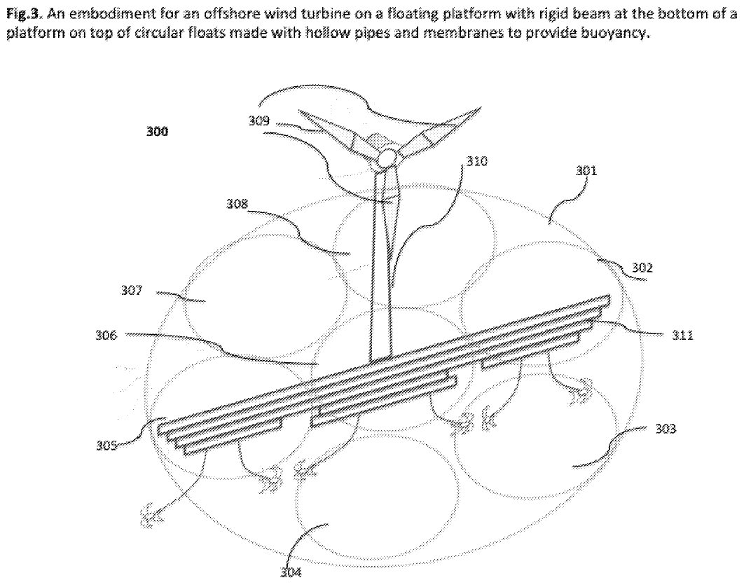

FIG. 3 depicts an arrangement 300 where the floating platform consisting of multiple such smaller floating platforms 302, 303, 304, 305, 306, 307, and 308 that are connected together in a closed packed arrangement that is itself encased with a peripheral bounding ring 301 to ensure tight packing of a flexible array of platforms and provide additional buoyancy as required. The central platform 306 has mounted on it the wind turbine tower 310 with rotors 309. In addition there is beam or rigid floating chambers 311 installed at the bottom of the floating platform, the beam provides extra strength and rigidity to the overall platform and especially serves to distribute the weight of the wind turbine 309 and 310 across the whole span of beam.

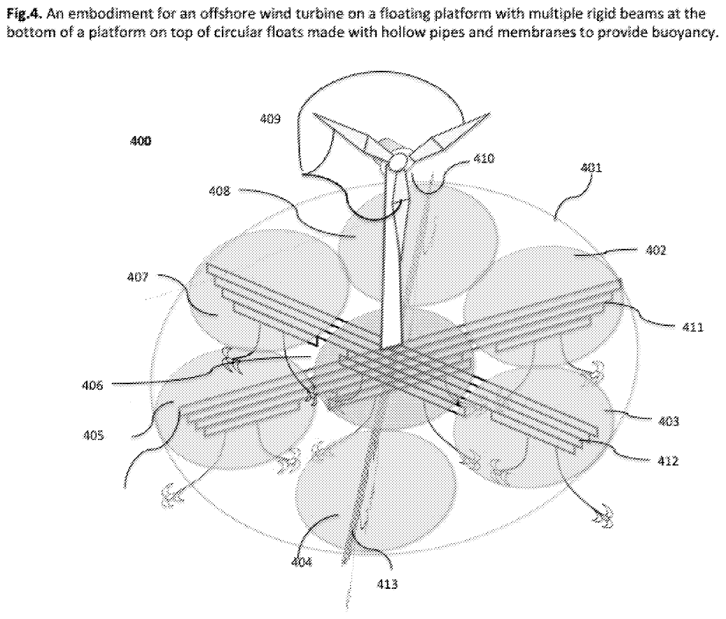

FIG. 4 depicts an arrangement 400 where the floating platform consisting of multiple such smaller floating platforms 402, 403, 404, 405, 406, 407, and 408 that are connected together in a closed packed arrangement that is itself encased with a peripheral bounding ring 401 to ensure tight packing of a flexible array of platforms and provide additional buoyancy as required. The central platform 406 has mounted on it the wind turbine tower 410 with rotors 409. In addition there are multiple beams or rigid floating chambers 411, 412 and 413 installed at the bottom of the floating platform 401. The beam provides extra strength and rigidity to the overall platform and especially serves to distribute the weight of the wind turbine 409 and 410 across the whole area of the platform 401 and ensuring rigidity and strength of system 400.

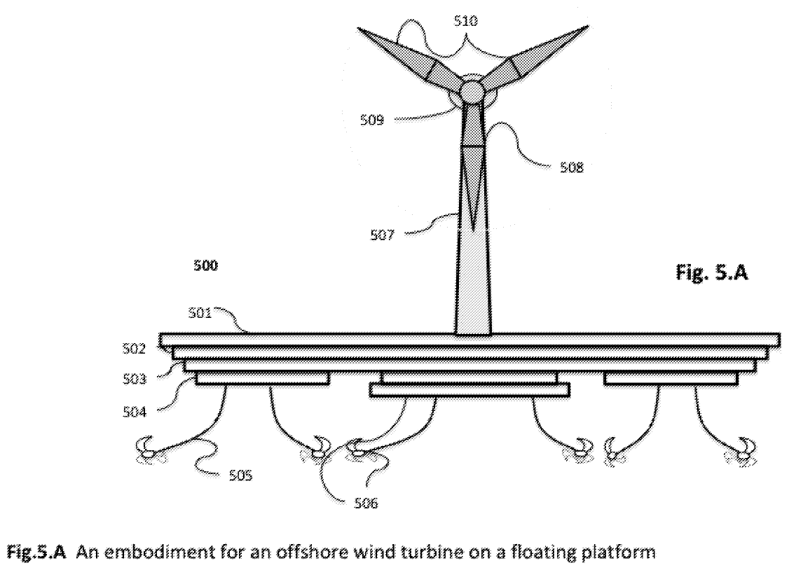

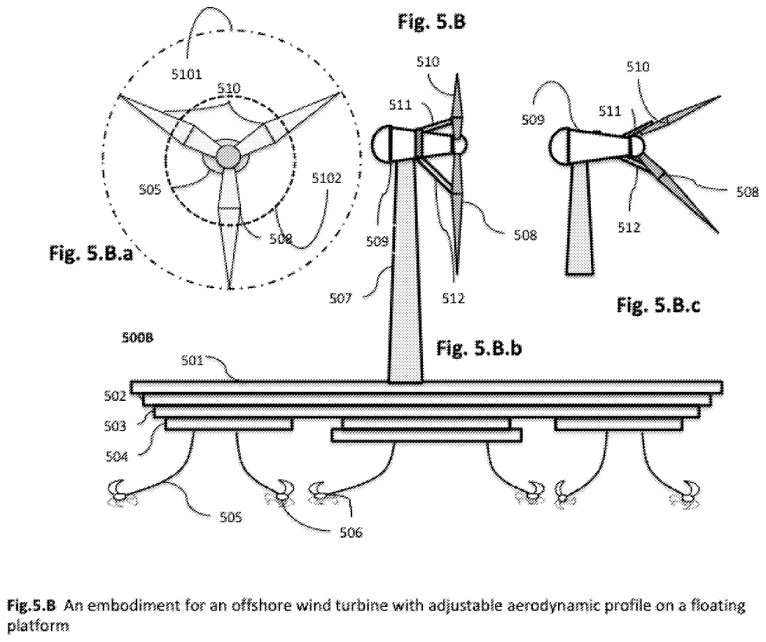

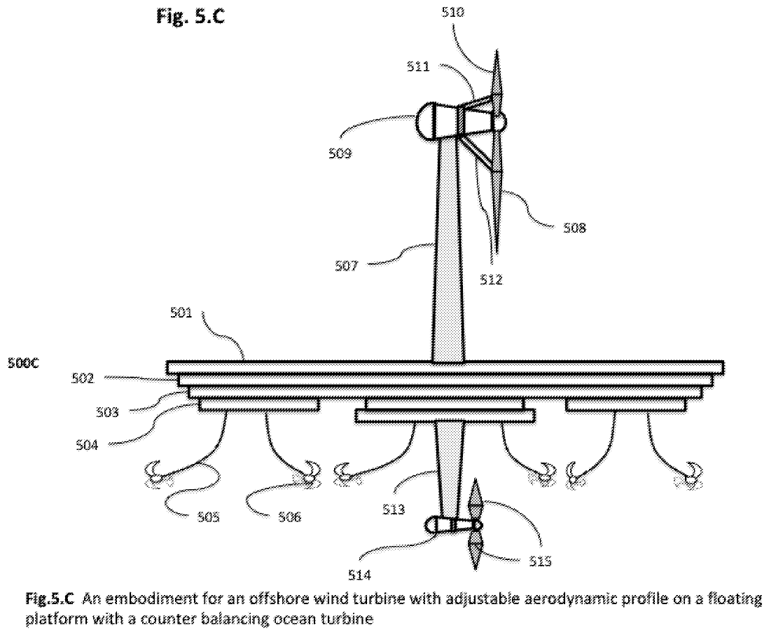

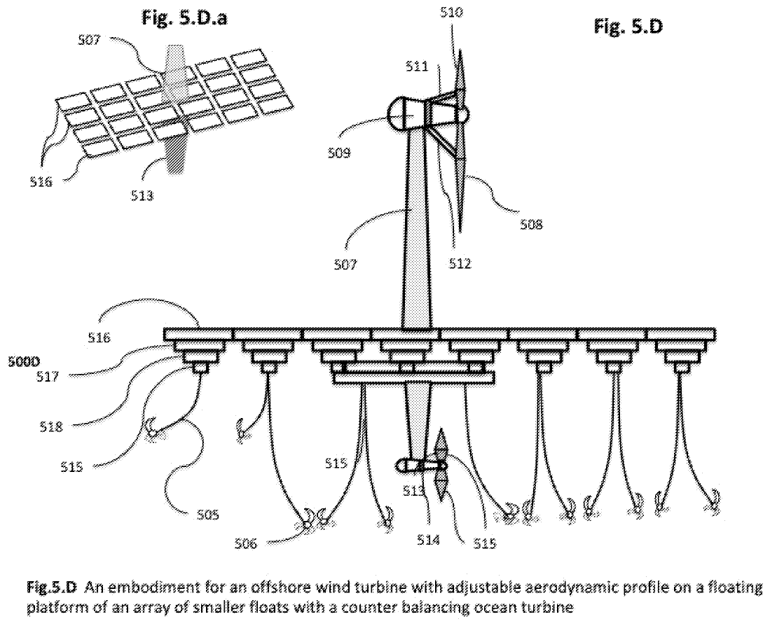

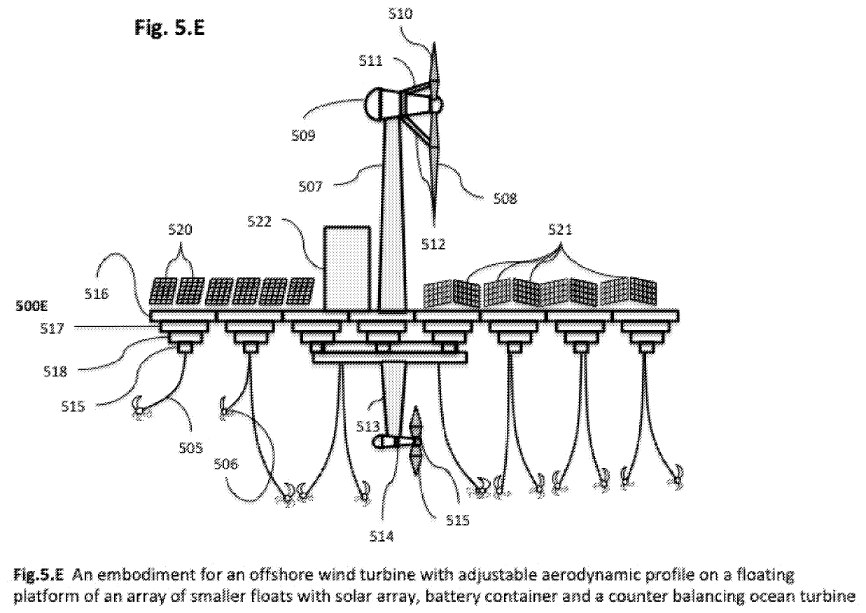

FIG. 5.A depicts an embodiment 500 for an offshore wind turbine on a floating platform shown in front view with the floating platform 501, sitting on top of hollow beam structure consisting of multiple chambers 502, 503, and 504 that are anchored to ground with cables and anchors 505 and 506. The wind turbine 509, is mounted on tower 507, with rotors 508 and 510.

FIG. 5.B depicts an embodiment 500B for an offshore wind turbine on a floating platform shown in side view with the floating platform 501, sitting on top of hollow beam structure consisting of multiple chambers 502, 503, and 504 that are anchored to ground with cables and anchors 505 and 506. The wind turbine 509 is mounted on tower 507, with rotors 508 and 510. The offshore wind turbine 505, 508, 510 has adjustable aerodynamic profile where in the area swept by the rotors 508 and 510 can be changed from large area 5101 down to much smaller area 5102 by connecting cross braces 511 and 512 that change the incident angle of the rotors.

FIG. 5.C depicts an embodiment 500C for an offshore wind turbine on a floating platform shown in side view with the floating platform 501, sitting on top of hollow beam structure consisting of multiple chambers 502, 503, and 504 that are anchored to ground with cables and anchors 505 and 506. The wind turbine 509 is mounted on tower 507, with rotors 508 and 510 and cross braces 511 and 512 connected to the blades 508 and 510. This offshore wind turbine with adjustable aerodynamic profile on a floating platform is further connected to a counter balancing ocean turbine 514, with blades 515 mounted on submerged keel 513.

FIG. 5.D depicts another embodiment 500D for an offshore wind turbine on a floating platform shown in side view with the array of floating platform 516, sitting on top of hollow array structure consisting of multiple chambers 517, 518, and 515 that are anchored to ground with cables and anchors 505 and 506. The wind turbine 509 is mounted on tower 507, with rotors 508 and 510 and cross braces 511 and 512 connected to the blades 508 and 510. This offshore wind turbine with adjustable aerodynamic profile on a floating platform connected to a counter balancing ocean turbine 514, with blades 515 mounted on submerged keel 513. This embodiment is for an offshore wind turbine with adjustable aerodynamic profile on a floating platform of an array of smaller floats with a counter balancing ocean turbine.

FIG. 5.E depicts another embodiment 500E for an offshore wind turbine on a floating platform shown in side view with the array of floating platform 516, sitting on top of hollow array structure consisting of multiple chambers 517, 518, and 515 that are anchored to ground with cables and anchors 505 and 506. The wind turbine 509 is mounted on tower 507, with rotors 508 and 510 and cross braces 511 and 512 connected to the blades 508 and 510. This offshore wind turbine with adjustable aerodynamic profile on a floating platform connected to a counter balancing ocean turbine 514, with blades 515 mounted on submerged keel 513. The platform also has placed on it solar photovoltaic array 520 and 521, and storage mechanism like batteries 522. This embodiment if an offshore wind turbine with adjustable aerodynamic profile on a floating platform of an array of smaller floats with solar array, battery container and a counter balancing ocean turbine.

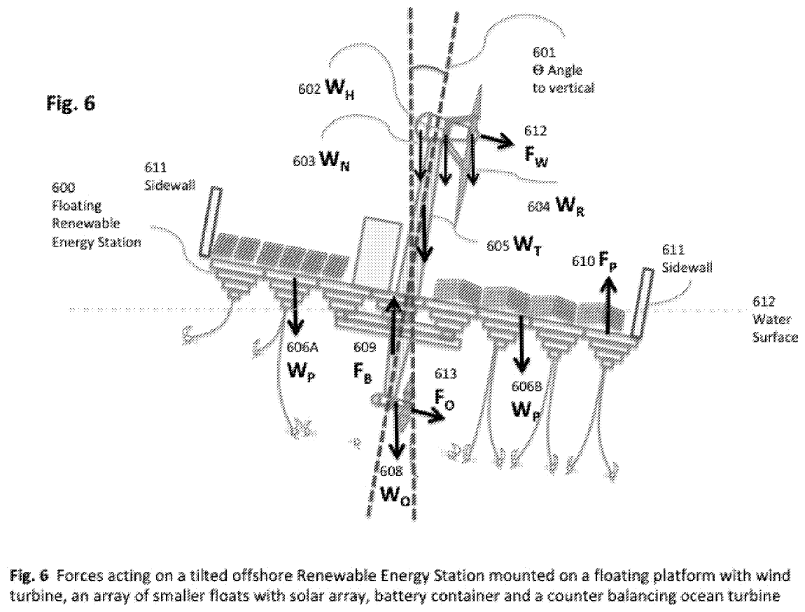

FIG. 6 depicts the gravitation and buoyancy forces acting on a tilted offshore renewable energy station mounted on a floating platform with wind turbine, an array of smaller floats with solar array, battery container and a counter balancing ocean turbine. The floating renewable energy station 600 is shown here tilted at angle θ 601 clockwise to true vertical due to destabilizing forces of wind, water or other source. The tilt leads to creation of clockwise torque the by the weight of the hub 602 W_{H}, weight of the nacelle 603 W_{N}, weight of the rotors 604 W_{R}, weight of tower 605 W_{T}, this is countered by counter-clockwise torque of weight of ocean turbine 608 W_{O}. The torque due to the buoyancy forces F_{B} of the submerged chambers is clockwise, while the torque due to the weight of platform 606A W_{P} is counter clockwise the one due to 606B W_{P} is counter-clockwise for near net zero contribution from that symmetric arrangement. However the large torque to high value of moment of arm is due the buoyancy force of the platform 610 F_{P}. Note side walls 611 are needed to ensure that the tilted raft does not collect water as it dips below the water surface 612. This arrangement ensures that the forces of gravity and buoyancy are inherently going to balance and self correct any tipping to avoid catastrophic toppling over of the floating structure. In another aspect, if there are very high-speed winds creating a large force 612 F_{W}, that causes further tipping over of the turbine, the ocean turbine can be actively operated to create a counteracting torque by thrust 613 F_{O} this can be operated in concert to balance the net torques and forces and stabilize the system as a whole. The power for rotating the ocean turbine turning it as propellers to create thrust and torques that oppose the tendencies of thrust and torques created by the wind turbine, this required power can be from stored power or generated by other renewable energy sources on the station such as solar. Thus the complete design of the system is done so as to enable counteracting the forces of the wind and rough seas to stabilize the station and ensure long life of operations.

In another aspect the floating renewable energy system is located offshore with electrical power generation from windmills, solar photovoltaic, ocean currents and other renewable energy sources that are stable and operable offshore under conditions of high wind, rough seas and heavy waves, allowing stable continual power export. FIG. 7 depicts an embodiment for an offshore renewable energy system 700 supplying steady power with power combiner 705, connected to and collecting variable power from different sources such as Wind turbine 701, ocean turbine 702, 703 solar photovoltaic, along with energy storage 706. The power combiner 705 is further connected to electrical machineries 704 such as pumps, fans, misters, robots etc that allow work to be done including mechanical balancing of the station and electrical balancing of the nature of power exported to electrical transmission line 707. This whole system is connected and controlled by a computer system 708 used to optimize and maximize the overall power and energy that is exported to the transmission line 707.

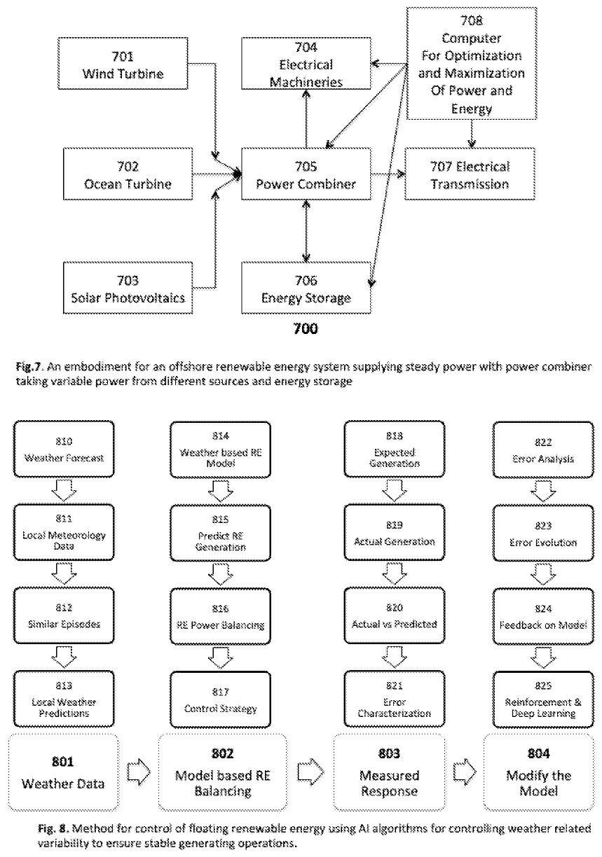

Another aspect of the invention is development of method to control the offshore system using the data collected from active sensing, deploying controllable actuators and machine learning based feedback mechanism to provide dynamic correction as required to ensure stable operation under high wind and wave conditions. FIG. 8 shows the method for control of floating renewable energy using Artificial Intelligence algorithms for controlling variability due to weather so as to ensure stable generating operations. The high level data cycle uses the data for weather 801, the balancing of various renewable energy sources is done using model for renewable energy generation 802, the measurements are used to characterize the response of the system 803, and the data collected is used to modify the model 804. The weather data 801, consists of using the local weather forecast 810, along with local meteorological data 811, using synoptic information from previous similar episodes 812, along with weather predictions 813 done locally using on board computers. The renewable energy generation is modeled 802, by leveraging first order physical model 814 defining the parameter of weather that impact the generation of various types of renewable sources wind, solar, and ocean. This model is used to predict the generation rates 815 for all types of renewables. The prediction of individual generation is then used to define the requirement of balancing 816, including the commitment to internal loads and exports to external transmission. The balancing requirements depend on the constraints requires choosing the right control strategy 817 from available set of options. The response to chosen strategy and settings are then measured 803 to characterize the efficacy of chosen strategy, this is done by taking the expected generation from each type of source 818, measuring, monitoring and collating the actual generation for the said types of source 819, comparing these actual and predicted values both for instantaneous and time integrated over varying durations (minutes, hours, days) 820, and then characterizing the errors thus computed 821. The error and efficacy of the chosen model is then used to enhance and modify the model appropriately 804. This consists of taking the errors collated and analyzing their nature 822 to correct for bias, bias drift and evolution 823, variability and robustness to noise. This analysis provides insight and feedback on the models chosen 824 and the most appropriate models are chosen combining reinforcement I and deep learning algorithms 825 to define the improved version of model, to enhance the performance in the next cycle of performance. This method ensures that the real time learning derived from cycle of data collection, prediction, comparison and feedback improves the performance over time and this refined model can be applied to the population as a whole or chosen locally for optimal performance.

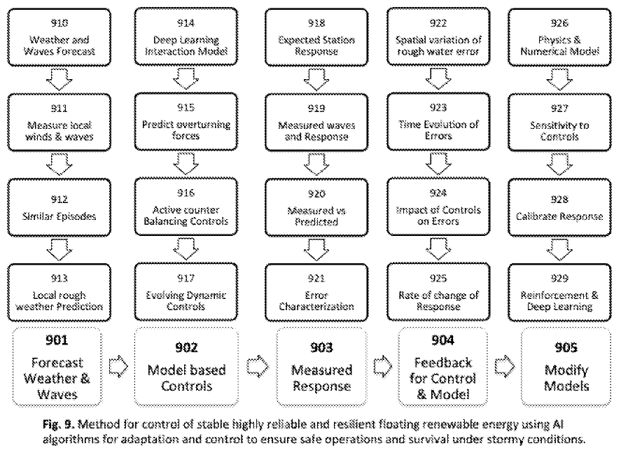

FIG. 9 shows the method for control of mechanical stability of floating renewable energy using Artificial Intelligence algorithms for controlling variability and concerns of stability due to weather such as wind, waves and mechanical forces so as to ensure stable generating operations. The high level data cycle uses the forecast for weather and waves 901, the mechanical stability and balancing is done using model for rigid structure, strength of materials and control surfaces 902, measurements are then used to characterize the response of the system 903, and the data collected is used to provide feedback for control and model 904, and finally this information is itself used to modify the model 905. The weather data 901, consists of using the forecast for weather, winds, and waves 910, along with real time measurements of local winds, waves and meteorological data 911, using synoptic information from previous similar episodes 912, along with weather predictions 913 done for expected conditions done locally using on board computers. The kinematical, dynamic, aero and hydrodynamic behavior of the floating system is modeled based on physics of the system 902, deep learning non-linear model 914 is used to predict interaction of shape with the surrounding, specifically to anticipate overturning forces 915 acting on the floating platform, the model is then used to actively counter the natural actions by modifying controls 916 such as aerodynamic shape of wind turbine or thrust created by the ocean turbine, and the interaction of the winds, waves and forces with system and controls is then predicted 917 in advance in an evolutionary manner. The response of the station 903 to the controls is evaluated in terms of expected response 918, and actual measurements of winds, waves and the mechanical structure 919, the measured and predicted responses are compared 920, to characterize the error at an instant of time and as function over a period 921. The feedback and control modeling 904, accounts for spatial variation of speeds of wind and roughness of water and waves 922 to account for the time evolution of the errors 923, and impact of the control settings chosen on the errors themselves 924, finally also accounting for the time dependent measurement of the rate of response 925. The models are then modified 905, by changing the important parameters used in physical and numerical models 926, modifying the gain, amplification and attenuation to change sensitivity to the controls 927, calibrating the responses by measuring the errors 928, these changes in the models are made using methods and approaches of reinforcement and deep learning algorithms 929.

The present invention described herein is a floating renewable energy that can be safely operable in hurricane prone areas consisting of novel floating structure design with ability to change the shape using aerodynamic principles and finally using novel advanced artificial intelligence methods to provide sophisticated control despite the complex aspects of the problem.

Further, the data processing functions disclosed herein may be performed by one or more program instructions stored in or executed by such memory, and further may be performed by one or more computing modules configured to carry out those program instructions. Computing modules are intended to refer to any known or later developed hardware, software, firmware, machine learning, artificial intelligence, fuzzy logic, expert system or combination of hardware and software that is capable of performing the data processing functionality described herein.

The foregoing descriptions of embodiments of the present invention have been presented for the purposes of illustration and description and not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, notwithstanding the fact that the elements of a claim are set forth below in a certain combination, it must be expressly understood that the invention includes other combinations of fewer, more or different elements, which are disclosed in above even when not initially claimed in such combinations. The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting certain combinations and even initially claimed as such, it to be expressly understood that one or more elements from a claimed combination can in some cases be excised from the combination and that the claimed combination may be directed to a sub-combination or variation of a sub-combination. Insubstantial changes from the claimed subject matter viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what specifically illustrated and described above, what is conceptually equivalent, what can be obviously substituted and also what essentially incorporates the essential idea of the invention. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for generating renewable energy on an offshore floating platform with sidewalls that is anchored to the sea bed, comprising:
a plurality of hollow chambers providing buoyancy being connected to the said floating platform;
a plurality of photovoltaic cells receiving sunlight, each of said plurality of voltaic cells being connected to an energy generation unit mounted on the said floating platform;
a plurality of wind turbines, driven by received wind, each of said plurality of wind turbines being connected to the said energy generation unit mounted on the floating platform;
a plurality of ocean turbines, each of said plurality of ocean turbines being connected to the said energy generation unit mounted on the floating platform;
a plurality of electrical energy storage units such as electrochemical batteries mounted on the floating platform;
the energy generation unit being operable to transfer energy and store said energy in a plurality of energy storage units mounted on the floating platform;
the said floating platform with multiple renewable energy sources to provide stable and resilient offshore renewable energy station exporting stable power to the external collection points for a grid which may be offshore or onshore.

2. An offshore renewable energy generation system of claim 1, wherein the floating platform is comprising:
a plurality of floating rings with polygonal or circular annular perimeter made of hollow pipes with ends of the pipes connected together to form buoyant ring;
a plurality of membranes and waterproof bottom surface in the area enclosed by the perimeter that has sidewalls to provide additional buoyancy;
the said plurality of floating rings and areas flexibly connected together to form a composite array of floating platforms;
the said array of plurality of floating encircled by additional buoyant rings to define perimeter of larger area platforms;
the structural mobilty and flexibility of the said large area floating platforms provides long field life and a reliable resilient floating structure.

3. An offshore renewable energy generation system of claim 1, wherein the composite array floating platform system further comprises:
a plurality of buoyant chambers flexibly connected together forming a flexible collection of submerged support on top of which the floating platform is mounted;
the complete composite array of interconnected floating platforms and the submerged chambers collection forming a stiff floating platform for mounting of wind turbine and other renewable sources.

4. An offshore renewable energy generation system of claim 1, wherein the composite array floating platform system further comprises:
a plurality of rigid buoyant chambers solidly connected together to form a plurality of buoyant structural beams;
a plurality of the rigid buoyant structural beams connected together to form a rigid submerged frame;
the complete composite array of interconnected floats and the rigid beam forms a stiff floating platform for mounting of wind turbine and other renewable sources.

5. An offshore renewable energy generation system of claim 1, wherein the system further comprises:
a tower designed to mount wind turbine connected to the composite array of floating platforms;
a complete set of wind turbine generator mechanism mounted on top of the said tower to generate electrical power from wind flow and forces.

6. An offshore renewable energy generation system of claim 5, wherein the floating renewable platform system further comprises:
control mechanism for changing the aerodynamic shape of the said wind turbine;
the said modification of aerodynamic shape by mechanisms reduces the wind forces and thrust acting on the turbine required during high wind conditions.

7. An offshore renewable energy generation system of claim 5, wherein the floating renewable platform system further comprises:
a portion of the said wind turbine tower is submerged as a column extending vertically down to form a keel;
a ocean turbine mounted on the submerged column;
the said ocean turbine operable to generate power from ocean current, and tidal flows and forces;
the placement of the said keel and the said ocean turbine counterbalances the gravitational forces acting on the wind turbine and tower, improving the mechanical stability of the overall system arrangement of floating platform, wind turbine and the ocean turbine and stabilizes the platform against overturning.

8. An offshore renewable energy generation system of claim 5, wherein the floating renewable platform system further comprises:
a plurality of solar photovoltaic panels and structures mounted on the floating platform;
a plurality of electrical energy storage units such as electrochemical batteries mounted on the floating platform;
a plurality of electrical power control and conversion units monted on the floating platform;
the placement of the said photovoltaic panels, the said storage units and the said power control units counterbalances the gravitational forces acting on the wind turbine and tower, improving the mechanical stability of the overall system arrangement of floating platform, and stabilizes the platform against overturning.

9. An offshore renewable energy generation system of claim 1, wherein the floating renewable platform system further comprises:
a plurality of sensors mounted on the various structural components of the platform to measure the mechanical vibrations and deflection of beams, platform and structures;
a plurality of computers, communication and information processing units connected to the sensors to provide realtime data for structural integrity and mechanical stability of the platform;
a plurality of control units connected to the said information processing units to compute in real time the forces acting on the components of the floating platform,
the said sensors measure the tilting of said platform and vibrations and deflections of structures on the said floating platform, the sensor information is processed by the said computers, communication and information processing units, the said information is used by the control units to prevent overturning, damage and enhance robustness of the floating platform.

10. An offshore renewable energy generation system of claim 8, wherein the floating renewable platform system further comprises:
a plurality of sensors mounted on the various structural components of the platform to measure the mechanical vibrations and deflection of beams, platform and structures;
a plurality of computers, communication and information processing units connected to the sensors to provide realtime data for structural integrity and mechanical stability of the platform;
a plurality of control units connected to the said information processing units to compute in real time the forces acting on the components of the floating platform,
a plurality of driver for the said ocean turbine connected to the said control unit,
the said sensors measure the tilting of the floating platform along with vibrations and deflections of structures on the said floating platform, the sensor information is processed by the said computers, communication and information processing units, the said information is used by the control units to drive the said ocean turbine to counteract the forces and torques due to the wind turbine and actively change the tilt and forces to avoid overturning and damage of the floating platform and enhance its robustness.

11. An offshore renewable energy generation system of claim 1, wherein the floating renewable platform system further comprises:
a plurality of photovoltaic cells receiving sunlight, each of said plurality of voltaic cells being connected to an energy generation unit mounted on the said floating platform;
a plurality of wind turbines, driven by received wind, each of said plurality of wind turbines being connected to the said energy generation unit mounted on the floating platform;
a plurality of ocean turbines, each of said plurality of ocean turbines being connected to the said energy generation unit mounted on the floating platform;
a plurality of electrical energy storage units such as electrochemical batteries mounted on the floating platform connected using electrical cables to an electrical power combiner unit;
a plurality of hydrolysis units to extract hydrogen from water;
a plurality of hydrogen storage tanks to store the said extracted hydrogen;
a plurality of fuel cell units to generate electricity from hydrogen fuel;
the said plurality of hydrolysis, storage and fuel cell units forming a hydrogen based storage and generation units for storage of electricity for later use;
the said power combiner unit connected with electrical cable to the said energy generation unit connected electrically to the solar photovoltaic cells;
the said power combiner unit connected with electric cables to the said wind energy generation unit;
the said power combiner unit connected with electric cables to the said ocean turbine energy generation unit;
the said power combiner unit connected with electric cables to a plurality of electrical machineries;
an electrical export and electrical transmission unit connected at one end to the power combiner unit and the other end connected to an electrical transmission line whose other end is connected to a distant collection and conversion unit;
the said electrical machineries, power combiner and the energy storage units are connected to a plurality of sensing and computer units;
the said computer unit measures the electrical parameters, processes the information and controls the operation of the various connected electrical generation units balancing the generated voltages, changing the generated currents and optimizing the power exported and the energy stored to ensure stable electrical operations.

12. A method for stable export of offshore renewable energy by balancing the amount of energy generated, stored and exported wherein the method further comprises:
providing a floating renewable platform comprising a plurality of electrical energy storage units such as batteries or hydrogen storage units connected electrically with a power combiner unit, the power combiner unit is connected electrically to a plurality of electrical generating units such as a plurality of solar photovoltaic cells, a plurality of wind energy generation units, a plurality of ocean turbine energy generation unit, a plurality of electrical machineries, an electrical export unit and an electrical transmission unit connected at one end to the power combiner unit and the other end connected to an electrical transmission line whose other end is connected to a distant collection and conversion unit;
providing a computer and controller assembly for obtaining the state of the plurality of electrical generating units, the plurality of electrical machineries, the power combiner, the plurality of energy storage units using a the plurality of sensing and computer units;
obtaining the measurements of the electrical parameters by the said controller and computer unit from the plurality of sensing and computer units;
processing the information from the electrical parameters of the plurality of generation units, the plurality of storage units, the power combiner unit and the electrical export unit;
determining the operation setting of the plurality of generation units, the plurality of storage units, the power combiner unit and the electrical export unit;
balancing the generated power by changing the generated currents from the plurality of generation units, the plurality of storage units, the power combiner unit and the electrical export unit;
optimizing the power exported by the electrical export unit and the energy stored in the plurality of storage units to ensure stable electrical operations defined as stable voltage and currents received at the distant collection and conversion unit.

13. A method of claim 12 for stable export of offshore renewable energy by balancing the amount of energy generated, stored and exported wherein the method further comprises:
collecting weather related data from remote and local sources;
modelling the expected generation from various renewable energy sources based on a plurality of physical, numerical and deep learning models leveraging the said local weather forecast as inputs to the said model, predicting the generations from various renewable sources and balancing the generation and storage by choosing the right control strategy;
measuring the response of the system and comparing to the predictions to characterize the error in modeling;
analyzing the nature in errors in prediction and evolution with time to identify modeling weakness and modifying the said model with deep learning and reinforcement learning algorithms;
modifying the model on a continual basis to improve the performance with usage and evolving to deliver lower errors over course of time and deliver stable power to the export transmission line with minimal deviation from commitment.

14. A method of claim 13 for stable offshore renewable energy export by balancing the amount of energy generated, stored and exported, wherein the collection of weather related data from remote and local sources, further comprises:
a plurality of global weather forecasts;
a collection of local meteorological data from specific sensors;
a synoptic summary of the weather pattern forecast;
identifying and using similar past episodes for learning from before;
predict the expected local weather with higher refinement.

15. A method of claim 13 for stable offshore renewable energy generation by changing the amount of energy generated, stored and exported, wherein the modelling of the expected generation from various renewable energy sources is based on a plurality of physical, numerical and deep learning models that leverage input of the said local weather forecast, further comprises:
a plurality of models for renewable energy generation for all the types of sources;
wherein the said models maybe based on physics of the machine and interaction with the natural input of the energy sources such as wind, sunshine or ocean current and tides;
wherein the said models maybe based on numerical computation of interaction of machine with the natural input of energy sources such as wind, sunshine or ocean current and tides;
wherein the said models maybe based on deep learning non-linear methods and predict the output from a generator based on the incoming natural sources;
using the models to predict the instantaneous renewable generation,
using the said generation information to define balancing requirements,
defining the control strategy to address the said imbalance.

16. A method of claim 13 for stable offshore renewable energy generation by changing the amount of energy generated, stored and exported, wherein measuring the response of the system and comparing to the predictions to characterize the error in modeling, and the analyzing the nature in errors in prediction and evolution with time to identify modeling weakness and modifying the said model with deep learning and reinforcement learning algorithms, further comprises:
tabulating the instantaneous predicted generation for each source;
enumerating the actual instantaneous generation from the said source;
comparing the instantaneous predicted and actual generation to compute the instantaneous errors in prediction for each of the said source;
characterizing the errors as function of source and meteorological measurements;
analyzing the errors computed by comparing the instantaneous predicted and actual generation;
tracking the evolution of these errors over a plurality of time durations;
deriving the statistical and temporal nature of errors to provide automated feedback on nature of the said models;
deploying deep learning and reinforcement learning methods to define the next iteration of model;
modifying the model on a continual basis to improve the performance with usage and evolving to deliver lower errors over course of time and deliver stable power to the export transmission line with minimal deviation from commitment.

17. A method for mechanically and dynamically stabilizing an offshore renewable energy generation system, wherein the method further comprises:
providing a collection of measurement from plurality of sensors mounted on the various structural components of the platform measuring mechanical vibrations and deflection of beams, platform and structures;
providing a plurality of computers, communication and information processing units connected to the said sensors;
providing a plurality of control units connected to the said information processing units to compute in real time the forces acting on the components of the floating platform;
providing energy from storage units to drive the said ocean turbine connected to the said control unit;
obtaining realtime data from said sensors for tilting and structural integrity, vibrations and deflections of structures on and mechanical stability of the said floating platform;
processing the sensor information by the said computers, information processing and communication units;
controlling the actuation of different control surfaces, wind turbine aerodynamic shape and ocean turbine settings to generate and modify forces and torques on the structure;
controlling the driving of the ocean turbine to counteract the forces and torques due to the wind turbine and actively change the tilt and forces to avoid overturning and damage of the floating platform and enhance its robustness.

18. A method of claim 17 for mechanically and dynamically stabilizing an offshore renewable energy generation system, wherein the method further comprises:
gathering weather and waves information from remote and local sources;
modelling the expected vibration, deformation, tilting and structural integrity of various beams, columns and frames on the offshore system based on a plurality of numerical and deep learning models;
measuring the response of the system and comparing to the predictions to characterize the error in modeling;
using the feedback signal to stabilize the operation under storms;
analyzing the nature in errors in prediction and evolution with time to identify modeling weakness and modifying the said model with deep learning and reinforcement learning algorithms;
modifying the model on a continual basis to improve the performance with usage and evolving to deliver lower errors over course of time and deliver stable power to the export transmission line with minimal deviation from commitment.

19. A method of claim 18 for mechanically and dynamically stabilizing an offshore renewable energy generation system, wherein the method further comprises:
using a plurality of forecasts for weather and ocean conditions;
collecting weather related data from remote and local sources;
collecting data on type, size and nature of waves in the ocean;
modelling the expected vibration, deformation, tilting and structural integrity of various beams, columns and frames on the offshore system based on a plurality of numerical and deep learning models;
using the said local weather and wave forecast as inputs to the said plurality of models, predicting the stablity and overturning of the platform from various forces;
actively deploying and evolving counter balancing controls of the generation and storage by choosing the right control strategy;
measuring the response of the system and comparing to the expected response predictions to characterize the error in modeling;
analyzing the nature in errors in terms of spatial prediction and evolution with time;
characterizing the dependence of errors on control settings;
determining the response time and rate of change with change in controls;
using a plurality of physics and numerical models to calibrate the response and sensitivity to controls;
identifying weakness in model and generating real time feedback on the said model;
change the control settings to stabilize the system;
using deep learning and reinforcement learning algorithms to modify the model using the feedback collected;
modifying the model on a continual basis to improve the performance with usage and evolving to deliver stable and safe operations of the station and ensure long operating lives despite strong storms, hurricanes and high waves.

20. A method of claim 18 for mechanically and dynamically stabilizing an offshore renewable energy generation system, wherein the method further comprises:
collecting weather related data from remote and local sources;
collecting data on type, size and nature of waves in the ocean;
modelling the expected vibration, deformation, tilting and structural integrity of various beams, columns and frames on the offshore system based on a plurality of numerical and deep learning models;
using the said local weather and wave forecast as inputs to the said model, predicting the stablity and overturning of the platform from various forces;
actively deploying counter balancing controls of the generation and storage by choosing the right control strategy;
measuring the response of the system and comparing to the predictions to characterize the error in modeling;
analyzing the nature in errors in prediction and evolution with time to identify modeling weakness and modifying the said model with deep learning and reinforcement learning algorithms;
modifying the model on a continual basis to improve the performance with usage and evolving to deliver stable and safe operations of the station and ensure long operating lives despite strong storms, hurricanes and high waves.
